(19) United States
(12) Patent Application Publication
(10) Pub. No.: US 2009/0162663 A1
(43) Pub. Date: Jun. 25, 2009

(54) WATERPROOF MULTI-LAYERED MOLDED ARTICLE

(75) Inventors: KUN-TSAN WU, Shindian (TW); LI-WEN TIEN, Shindian (TW)

Correspondence Address: PCE INDUSTRY, INC.;ATT. Steven Reiss, 458 E. LAMBERT ROAD, FULLERTON, CA, 92835, US

(73) Assignee: FIH (HONG KONG) LIMITED, Kowloon (HK)

(21) Appl. No.: 12/168,226

(22) Filed: Jul. 7, 2008

(30) Foreign Application Priority Data
Dec. 20, 2007 (CN) 200710203286.3

(51) Int. Cl. B32B 27/06

(52) U.S. Cl. 428/421

(57) ABSTRACT

A waterproof multi-layered molded article (10) is provided. The waterproof multi-layered molded article includes a substrate (14), a soft layer (12) directly formed on the substrate, and a resilient and transparent waterproof layer (16). The waterproof layer is directly formed on the soft layer. The soft layer is positioned between the substrate and the waterproof layer.

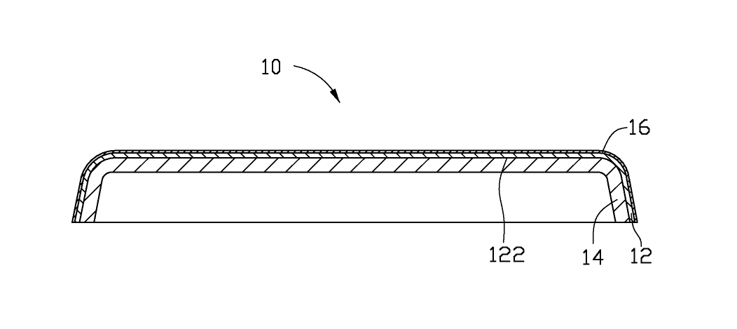

### CROSS-REFERENCE TO RELATED APPLICATIONS

This application is one of the ten related co-pending U.S. patent applications listed below. All listed applications have the same assignee and were concurrently filed herewith. The disclosure of each of the listed applications is incorporated by reference into all the other listed applications.

| Attorney | | |
|---|---|---|
| Docket | | |
| No. | Title | Inventors |
| US18024 | MULTI-LAYERED MOLDED ARTICLE | Kun-Tsan Wu et |
| | WITH DECORATIVE LAYER AND | al. |
| | METHOD | |
| US18396 | MULTI-LAYERED MOLDED ARTICLE | Kun-Tsan Wu et |
| | WITH IMPROVED BONDING | al. |
| | BETWEEN LAYERS | |
| US18397 | MULTI-LAYERED MOLDED ARTICLE | Kun-Tsan Wu et |
| | WITH MOISTURE PROTECTION | al. |
| US18398 | MULTI-LAYERED MOLDED ARTICLE | Kun-Tsan Wu et |
| | WITH MOISTURE PROTECTION | al. |
| US18399 | WATERPROOF MULTI-LAYERED | Kun-Tsan Wu et |
| | MOLDED ARTICLE | al. |
| US18400 | MULTI-LAYERED MOLDED ARTICLE | Kun-Tsan Wu et |
| | WITH TACTILITY | al. |
| US18401 | MULTI-LAYERED MOLDED ARTICLE | Kun-Tsan Wu et |
| | WITH EMI PROTECTION | al. |
| US18402 | METHOD FOR MAKING | Kun-Tsan Wu et |
| | MULTI-LAYERED MOLDED | al. |
| | ARTICLES | |
| US18403 | METHOD FOR MAKING | Kun-Tsan Wu et |
| | MULTI-LAYERED MOLDED | al. |
| | ARTICLES | |
| US18404 | METHOD FOR MAKING | Kun-Tsan Wu et |
| | MULTI-LAYERED MOLDED | al. |
| | ARTICLES | |

### BACKGROUND

1. Field of the Invention

The present invention relates to multi-layer molded articles.

2. Description of related art

Molded articles, such as molded shells, are widely used in many technological fields. One example is a molded shell used with a portable electronic device (e.g., a mobile phone) for protecting internal electronic components. Another example is a molded shell used with furniture (e.g., a mini sofa) to provide decoration.

The molded shells may include a plastic substrate having some kind of decorative and/or protective (hereinafter “second”) layer formed thereon. The molded shell may be made using an insert molding process. The second layer is placed in the mold cavity and then bonds to the molten plastic injected into the mold for forming the substrate.

Various difficulties may be faced when manufacturing this multi-layer molded article.

Therefore, there is room for improvement within the art.

### BRIEF DESCRIPTION OF THE DRAWINGS

Many aspects of the present waterproof multi-layered molded article can be better understood with reference to the following drawing. This drawing is not necessarily drawn to scale, the emphasis instead being placed upon clearly illustrating the principles of the present waterproof multi-layered molded article. Moreover, in the drawing like reference numerals designate corresponding parts throughout the view. Wherever possible, the same reference numbers are used throughout the drawing to refer to the same or like elements of an embodiment.

The FIG. shows a cross-sectional view of a waterproof multi-layered molded article according to an exemplary embodiment.

### DETAILED DESCRIPTION OF THE EXEMPLARY EMBODIMENTS

Referring to the FIG, a multi-layered molded article 10 is shown. Article 10 includes a soft layer 12, a substrate 14 and a waterproof layer 16. The soft layer 12 is between the substrate 14 and the waterproof layer 16.

The substrate 14 can be molded by injection molding. The substrate 14 can be formed by injection molding a moldable material. The moldable material can be any of plastic, rubber, and silicon. The plastic material can be any of polyvinylchloride resin (PVC), polyethylene terephthalate (PET), acrylonitrile-butadiene-styrene (ABS), polycarbonate (PC), polyimide (PI), liquid crystal polymer (LCP), polyetherimide (PEI), polyphenylene sulfide (PPS), polystyrene (PS), polypropylene (PP). In particular, ABS and PC exhibit good adhesion to many softer materials.

The soft layer 12 can be made of a material that is soft relative to the substrate 14. Exemplary soft materials include leather (natural and artificial), all types of fabrics, woven clothes, textiles, and nylon. One surface of the soft layer 12 acts as a bonding surface 122. The bonding surface 122 should have a rough or coarse surface, formed by, for example, a plurality of tiny pores or projections (schematically shown). For some soft materials, the pores and projections of the bonding surface 122 may be a natural property of the material. For other soft materials, the pores and projections may be formed by grinding or sandblasting the bonding surface 122. The tiny pores and projections of the bonding surface 122 interlock with the molten material used to make substrate 14, thereby increasing the bonding of the soft layer 12 to the substrate 14.

The waterproof layer 16 is a resilient transparent layer and may be made of one of a polyvinyl acetate (i.e., PVA) material, a polystyrene material, a PVC material, a polysulphide material, and/or an organosiliconpolymer material. The waterproof layer 16 can be formed on the soft layer 12 by such steps as follows. The soft layer 12 is immersed into a chemical waterproofing solution for a certain time period, according to the waterproofing solution used. After immersion, the soft layer 12 is removed from the waterproofing solution and air-dried. Thus, the waterproof layer 16 is directly formed on the soft layer 12.

In manufacturing the multi-layered molded article 10, after forming the waterproof layer 16 on the soft layer 12, the substrate 14 is integrally formed with the combined waterproof layer 16/soft layer 12. A typical insert molding decorating (IMD) technology is implemented to insert mold the substrate 14 with the combines waterproof and soft layers.

Alternative manufacturing methods can be implemented for making the multi-layered molded article 10. The substrate 14 can be insert molded with the soft layer 12 by a typical IMD technology. The waterproof layer 16 is then directly formed on an exterior surface of the soft layer 12 by such means as heat pressing, or the like, instead of the present immersion and drying steps.

One advantage of the present embodiment embodies that the multi-layered molded article 10 can be provided with leather or fabric appearance and tactility using the soft layer 12. Such appearance and tactility are protected by the waterproof layer 16 from being badly degraded by water/liquid vapor.

It is to be understood, however, that even through numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A multi-layered molded article, comprising:
a substrate;
a soft layer directly formed on the substrate; and
a resilient and transparent waterproof layer directly formed on the soft layer, the soft layer positioned between the substrate and the waterproof layer.

2. The waterproof multi-layered molded article as claimed in claim 1, wherein the waterproof layer is made of a material chosen from the group consisting of: polyvinyl acetate, polystyrene, polyvinyl chloride, polysulphide, and organo-silicon polymers.

3. The waterproof multi-layered molded article as claimed in claim 1, wherein the soft layer is made of a material chosen from the group consisting of leather and fabric.

4. The waterproof multi-layered molded article as claimed in claim 1, wherein the soft layer is made of a material selected from the group consisting of: natural leather, man-made leather, cotton fabric, wool fabric, plastic fabric, and a nylon fabric.

5. The waterproof multi-layered molded article as claimed in claim 4, wherein the soft layer comprises a bonding surface, the bonding surface having a plurality of tiny pores or protrusions.

6. The waterproof multi-layered molded article as claimed in claim 5, wherein the tiny pores or protrusions result from the soft layer being made of a cotton.

7. The waterproof multi-layered molded article as claimed in claim 5, wherein the bonding surface is treated to form the tiny pores or protrusions.

8. The waterproof multi-layered molded article as claimed in claim 1, wherein the substrate is made of made of a material chosen from the group consisting of a plastic, a rubber, and a silicon.
